(19) United States
(12) Patent Application Publication
(10) Pub. No.: US 2013/0042627 A1
(43) Pub. Date: Feb. 21, 2013

(54) COMBUSTION CHAMBER HEAD OF A GAS TURBINE WITH COOLING AND DAMPING FUNCTIONS

(71) Applicants: Miklos GERENDAS, Am Mellensee (DE); Sermed SADIG, Berlin (DE); Jochen BECKER, Rangsdorf (DE); Jonathan F. CARROTTE, Leicester (GB); Jochen RUPP, Burton-on-Trent (GB)

(72) Inventors: Miklos GERENDAS, Am Mellensee (DE); Sermed SADIG, Berlin (DE); Jochen BECKER, Rangsdorf (DE); Jonathan F. CARROTTE, Leicester (GB); Jochen RUPP, Burton-on-Trent (GB)

(73) Assignee: ROLLS-ROYCE DEUTSCHLAND LTD & CO KG, Blankenfelde-Mahlow (DE)

(21) Appl. No.: 13/587,663

(22) Filed: Aug. 16, 2012

(30) Foreign Application Priority Data
Aug. 19, 2011 (EP) 11006812.9

(51) Int. Cl. F02C 7/18; F02C 7/24

(52) U.S. Cl. 60/782; 60/725; 60/806

(57) ABSTRACT

A combustion chamber head of a gas turbine has a substantially annular combustion chamber outer wall 18 as well as a substantially annular combustion chamber inner wall 42 and several burners 6 distributed around the circumference. The combustion chamber head 5 has an inflow-side wall 13 which together with a wall 14 facing the combustion chamber 7 forms a combustion chamber head volume 15. The inflow-side wall 13 is provided with at least one inflow opening 32, the wall 14 facing the combustion chamber 7 is provided with at least one outflow opening 17 for connecting the combustion chamber head volume 15 to the combustion chamber 7, and at least one cooling air duct 29 is provided in the wall 14 facing the combustion chamber 7. A method for cooling and damping of the combustion chamber head is also disclosed.

This application claims priority to European Patent Application EP11006812.9 filed Aug. 19, 2011, the entirety of which is incorporated by reference herein.

This invention relates to a combustion chamber head of a gas turbine. The combustion chamber includes, as known from the state of the art, a substantially annular combustion chamber outer wall as well as a substantially annular combustion chamber inner wall. The two combustion chamber walls are connected to the combustion chamber head. The combustion chamber head has at least one opening through which at least one burner can be inserted and hence connected to the combustion space. At least one heat shield protects the combustion chamber head from the hot combustion gases. The combustion chamber head can be designed in one piece or consist of several segments.

The arrangement of a conventional heat shield for the combustion chamber head is shown in Specification DE 44 27 222 A1 Such a heat shield protects the combustion chamber head against hot gases and is to be cooled on the side facing away from the combustion chamber interior. For this, cooling air is supplied to the rear side of the heat shield, impinges thereon, and flows around a plurality of cylinders provided for boosting heat transfer. Subsequently, the cooling air leaves the space between heat shield and combustion chamber head via inclined effusion holes showing in the direction of the burner swirl. The combustion chamber head includes an end wall, a front plate and a heat shield. This is a triple-wall design of a combustion chamber head with an open volume between the end plate and the front plate. The purpose of the end plate is to conduct the flow of air coming from the compressor.

The principle of an impingement-effusion cooled combustion chamber wall element is explained in Specification WO 92/16798 A1. Cooling air flows through orthogonal holes in an outer wall and impinges on an inner wall. Both walls form a closed volume which the cooling air leaves via inclined effusion holes. In the process, a cooling film forms on the hot side of the inner wall protecting the latter against the hot combustion gases. In EP 0 971 172 B1, the principle of the impingement-effusion cooled combustion chamber wall has been expanded by the aspect of damping combustion chamber pressure fluctuations. Here, the effusion holes, together with the volume enclosed by the walls containing the impingement and effusion holes, form a multitude of interconnected Helmholtz resonators. This arrangement enables high-frequency pressure fluctuations in the range of 5 kHz to be dampened. The distance of the damping holes from one another and the distance of the walls is variable to provide a broad damping spectrum.

In their publication of 2003 “The absorption of axial acoustic waves by a perforated liner with bias flow” (J. Fluid Mech. (2003), vol. 485, pp. 307-335, Cambridge University Press), Eldredge and Dowling provided a model for describing the acoustic damping effect of perforated wall elements. According to this, the absorption of acoustic pressure fluctuations by perforated wall elements is large with a single-wall arrangement. If a second wall is introduced, as with the impingement-effusion arrangement, absorption is significantly influenced by the wall including the impingement cooling holes. Increasing distance allows the influence to be reduced and brought close to the damping effect of a single-wall damper.

A possibility for providing an enlarged damping volume is shown in Specification EP 0 576 717 A1. Here, an additional volume providing for the formation of a Helmholtz resonator volume is connected to a double-wall element. The resonator volume is dimensioned in accordance with the pressure waves occurring.

Specification CA 26 27 627 shows a heat shield provided with fins on the side facing away from the combustion chamber. The fins are connected to each other at one end, with their open side showing to the combustion chamber inner and outer walls. Cooling air impinges between the fins and is ducted by the fins to the combustion chamber walls. The objective of this arrangement is to prevent the impingement cooling jets from excessively affecting each other. It is thereby intended to avoid the effects of the entering cross flow.

Specification US 2007/0169992 A1 deals with the problem of combining a high impingement cooling effect with a large distance of the impingement and effusion walls ensuring a large damping volume. The solution proposed provides for bridging the distance between the two wall elements by means of guide tubes directed from the cold combustion chamber outer wall to the hot combustion chamber wall to enable an optimum impingement cooling distance while maintaining a large damping volume.

DE 10 2009 032 277 A1 shows a combination of the functions of cooling and damping inside the combustion chamber head, where the air for cooling and damping is supplied to the combustion chamber head from the inner and outer annulus, which is situated between the inner and outer combustion chamber casing, respectively, and the combustion chamber wall. Here, the air is first used for cooling the combustion chamber head and then for damping of combustion chamber pressure fluctuations. In so doing, it intersects the flow path of the cooling air without being able to mix with the latter.

The above mentioned concepts known from the state of the art feature a variety of drawbacks:

Conventional heat shields (DE 44 27 222 A1) have a small distance between head plate and heat shield. This is required to obtain an adequate impingement cooling effect (WO 92/16798 A1). in order to make use of the viscous damping effect of a perforated hole plate, a large damping volume is, however, to be provided behind the heat shield (Eldredge and Dowling 2003). Otherwise, only high-frequency range of the combustion chamber pressure fluctuations would be dampable by application of the principle of coupled Helmholtz resonators (EP 0 971 172 B1). If an additional volume is connected to a double-wall element (EP 0 576 717 A1), this volume is required to be trimmed to a frequency expected, this diminishes the advantage of a perforated wall element as broad-band damper. Since both wall elements are still situated close to each other, the negative influence of the outer impingement cooling wall cannot be ruled out.

The inclined effusion holes shown in the above mentioned publications provide for high film-cooling efficiency. However, the damping effect obtained therewith is inferior to that of vertical holes. It can therefore be stated that the requirements on the damping and cooling effects are in conflict.

The combustion chamber head with the additional, flow-conducting end plate shown in Specification DE 44 27 222 A1 is disadvantageous in that the volume between end plate and front plate does not represent a closed volume decoupled from the burner. It may therefore occur that pressure fluctuations in this volume affect the stability of the burner. Accordingly, the end plate is only intended as a flow-conducting element.

The design according to Specification US 2007/0169992 A1 provides for a high impingement cooling effect while maintaining a large damping volume. However, since every impingement cooling hole is to be connected to a tube, this design is very complex and basically impracticable for installation in a combustion chamber with several thousands of impingement cooling holes. Furthermore, the guide tube entails a loss of volume and an increase in weight, so that this method is ineffective.

In accordance with DE 10 2009 032 277 A1, the cooling air is limited to the air quantity which still permits good damping of the combustion chamber pressure fluctuations, since both functions are performed consecutively by the same air quantity. It is possible that when close to a very hot flame, the air quantity designed for optimum damping is no longer suitable for limiting the wall temperature to a range in which a long service life of the component can be expected.

A broad aspect of the present invention is to provide a combustion chamber head of the type specified at the beginning as well as a method for cooling and damping of a combustion chamber head, which are highly efficient and avoid the disadvantages of the state of the art, while being simply designed and easily and cost-effectively producible.

The combustion chamber head is thus split in accordance with the invention into two cooling airflows independent of one another. These flows are not mixed with one another. The one airflow is used for flowing through the combustion chamber head volume to ensure noise damping there. The other airflow is used exclusively for cooling of the heat shield. It is possible with this embodiment in accordance with the invention to optimize both functional aspects independently of one another, i.e. both damping and cooling.

For the combustion chamber of a gas turbine, it is thus provided in accordance with the invention that the paths of the damping air and the cooling air are designed independently of one another, where the air path for cooling of at least one heat shield is routed starting from the passage for the burners through the combustion chamber head, where the heat shield cooling air initially flows inside cooling ducts, radially outwards relative to the burner axis, to the cold side of the heat shields, and then radially inwards relative to the combustion chamber or engine axis and then outwards through cooling ducts in the direction of the combustion chamber walls, and where this cooling air when exiting the cooling ducts is used as a starter film for wall cooling, with this air exiting at a small angle to the combustion chamber wall on the hot side of the combustion chamber head through one slot each or through holes close to the combustion chamber inner and outer walls.

The damping air enters at a suitable point, regardless of the cooling air, at least one closed area of the combustion chamber head and intersects, when passing into the combustion chamber through at least one opening in at least one web or pin, the cooling airflow which is flowing along at least one web or pin on its outside, without being in flow communication with said cooling airflow.

The solution in accordance with the invention allows a sufficiently cooled damping element to be integrated into the head plate of a combustion chamber with effective and high-degree acoustic damping. Dampers optimized for low frequencies usually require a large construction volume. The solution in accordance with the invention allows effective use of the construction space available in the combustion chamber in order to permit broad-band damping particularly in the low-frequency range (frequencies below 2000 Hz). To do so, the broad-band damping effect of perforated walls, which is usually low, is connected to that of a Helmholtz resonator, which has a high effect. By skilful use of the volume between the combustion chamber heads for approximation of a plenum-like flow to the damping holes, a particularly high damping effect can be achieved.

As a result, the already high damping effect of a Helmholtz resonator can be far exceeded. The concept however also allows the combustion chamber head to be designed as a pure Helmholtz resonator, or as a perforated wall with pure broad-band damping function without resonance.

While standard double-wall configurations require a short distance between the two walls to permit a sufficient cooling effect, the solution in accordance with the invention requires only a convective cooling concept for the thermally loaded wall.

The concept thus combines the conflicting aims of cooling and damping by simple means practical for actual use, making it possible to integrate a large volume inside a double-wall structure and nevertheless achieve a high cooling effect by an altered flow into the volume.

By separating the air paths for cooling and damping, the air quantity for cooling can be increased such that the integrity of the component is assured despite a high thermal load in the vicinity of a hot flame. By separating the metering of cooling and damping air quantities, the damping of the combustion chamber pressure fluctuations is not negatively influenced as a result. To increase the effect of the cooling air, it is, after being used as heat shield cooling air, still used as a starter film for wall cooling, as a result of which the separate air for a starter film can be saved.

Due to the possibility of an intensive cooling of the heat shield, the device is suitable not only for combustion chambers with lean burners (air mass flow/fuel mass flow at burner>15), but also for combustion chambers with diffusion burners (air mass flow/fuel mass flow at burner<15) in the classic rich/lean combustion concept.

The present invention is described in the following in light of the accompanying drawings showing exemplary embodiments. In the drawings,

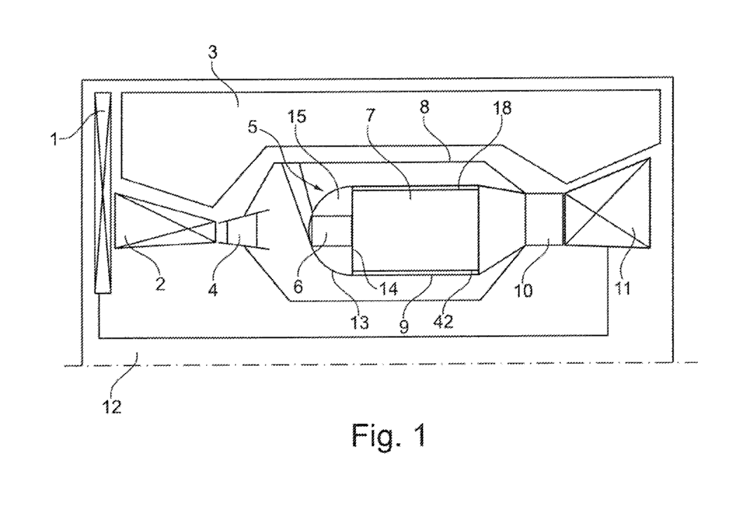

FIG. 1 shows a schematic partial sectional view of a gas turbine,

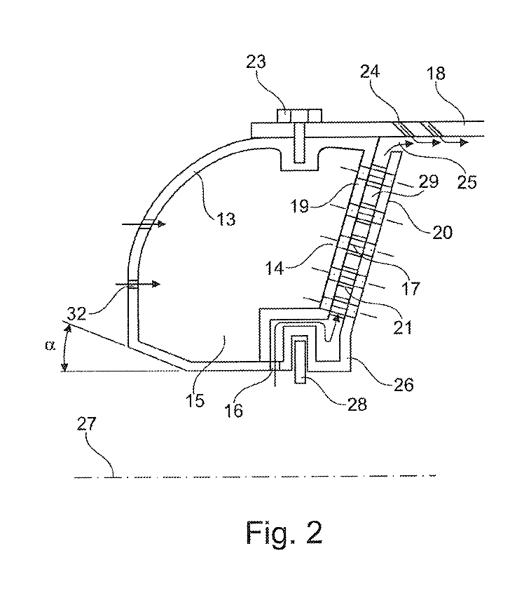

FIG. 2 shows an enlarged detail view of an exemplary embodiment of the combustion chamber head in accordance with the present invention,

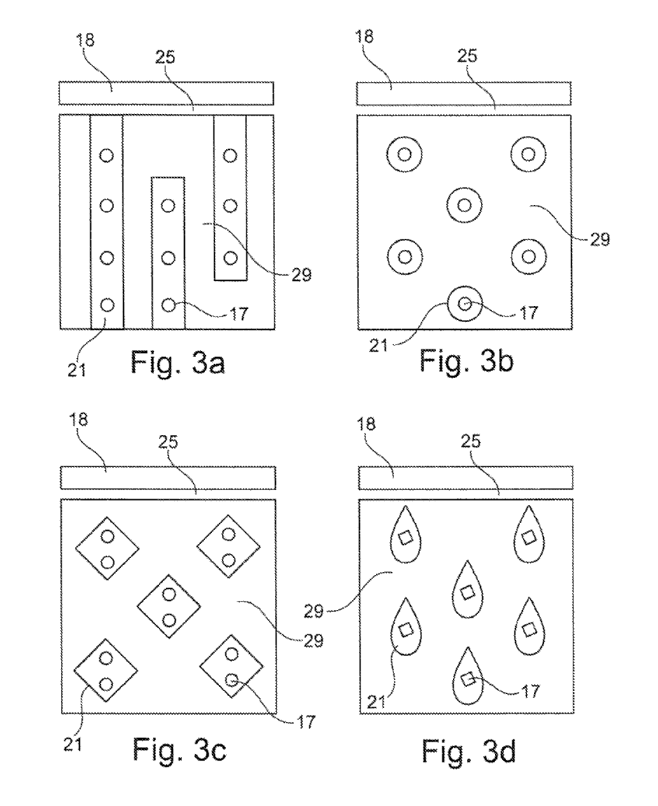

FIGS. 3a-3d show different design variants of elements in accordance with the present invention for boosting heat transfer,

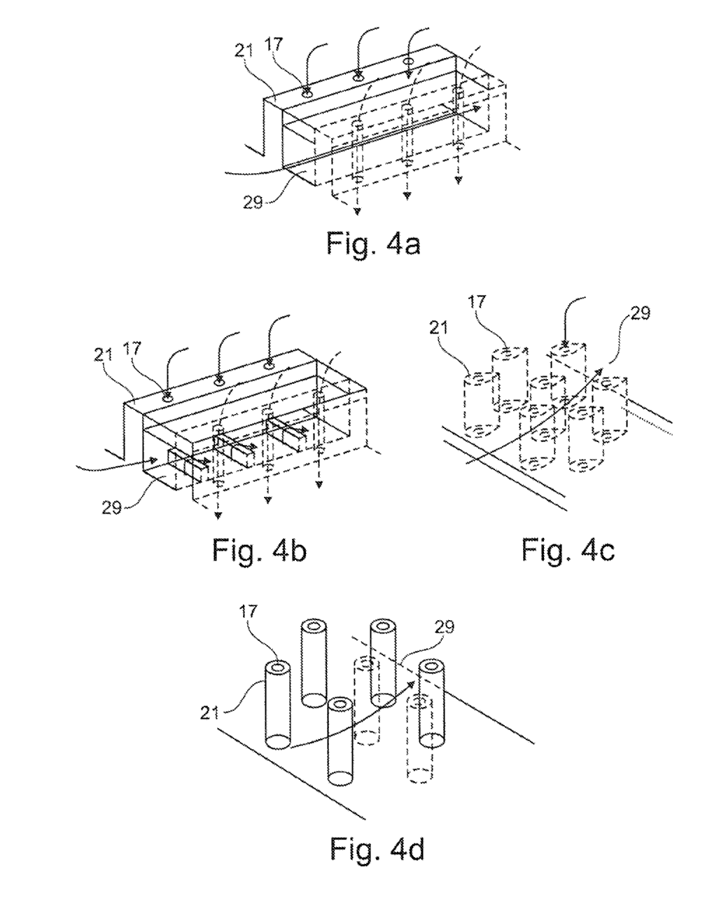

FIGS. 4a-4d show perspective simplified partial views of the flow routed through the cooling air duct, passing the heat transfer-boosting elements,

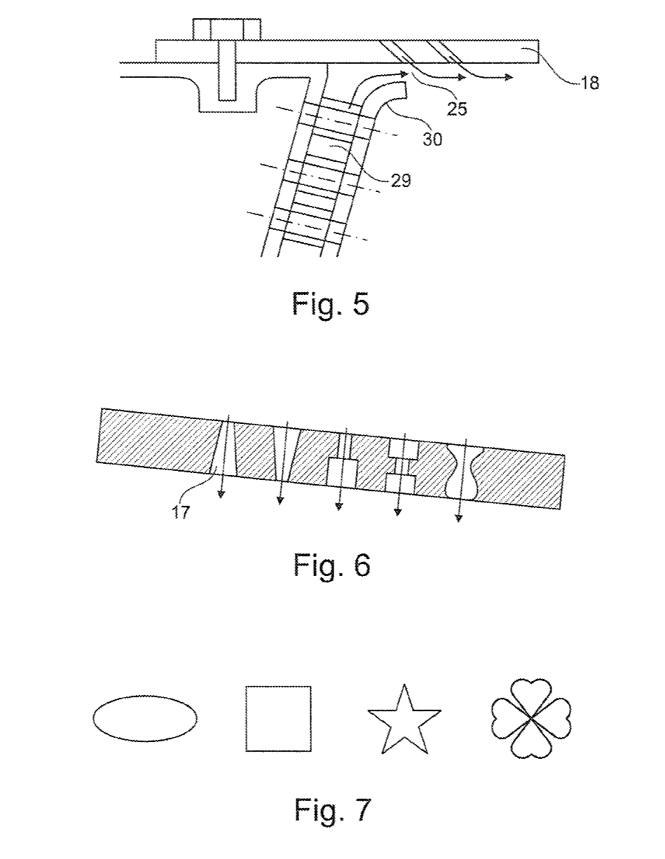

FIG. 5 shows an enlarged detail view of an embodiment of a heat shield lip,

FIG. 6 shows a sectional view of outflow openings/damping openings,

FIG. 7 shows different design variants of cross-sections of the outflow openings/damping openings,

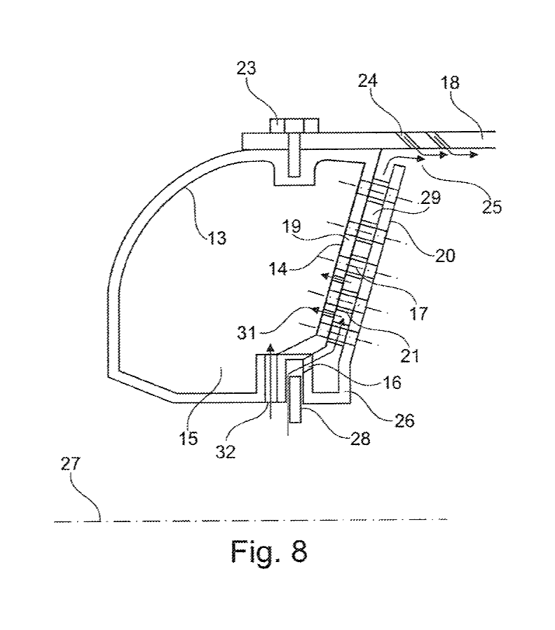

FIG. 8 shows a detail sectional view, by analogy with FIG. 2, of a modified exemplary embodiment of the combustion chamber head in accordance with the present invention, with a flow routed around the burner seal and the connecting openings between flow duct and volume,

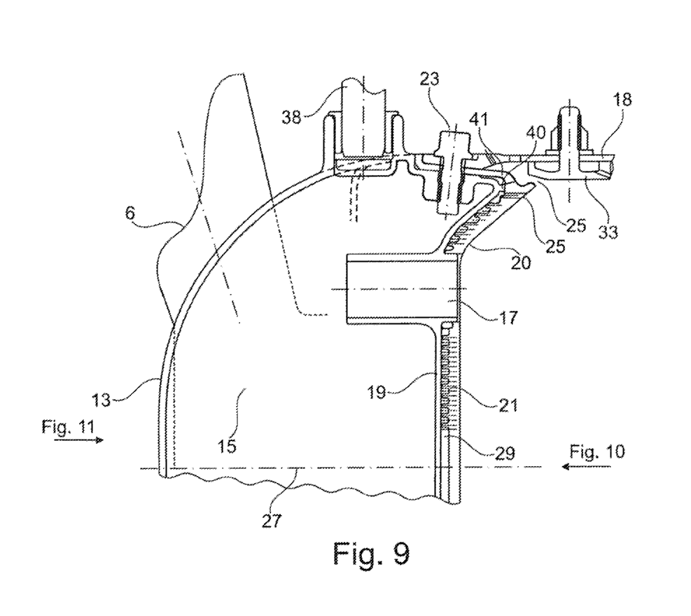

FIG. 9 shows a view of a further exemplary embodiment, by analogy with FIGS. 2 and 8, of the combustion chamber head with only one damping opening/outflow opening,

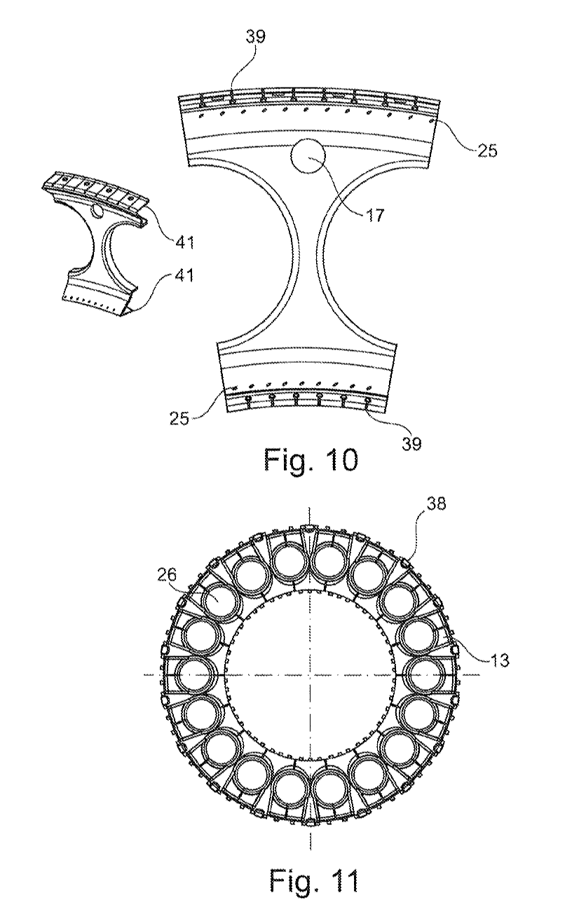

FIG. 10 shows a view of a heat shield in accordance with the present invention, as illustrated in FIG. 9, in perspective view and front view,

FIG. 11 shows a view of a combustion chamber head in accordance with the present invention, made up of several segments/burners,

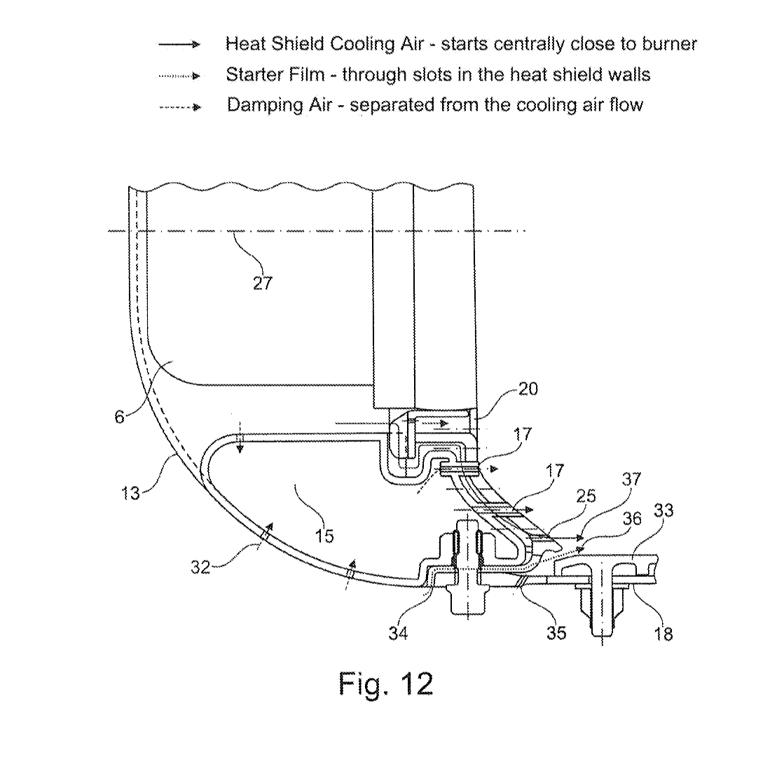

FIG. 12 shows a further exemplary embodiment of a combustion chamber head in accordance with the present invention with several damping openings/outflow openings,

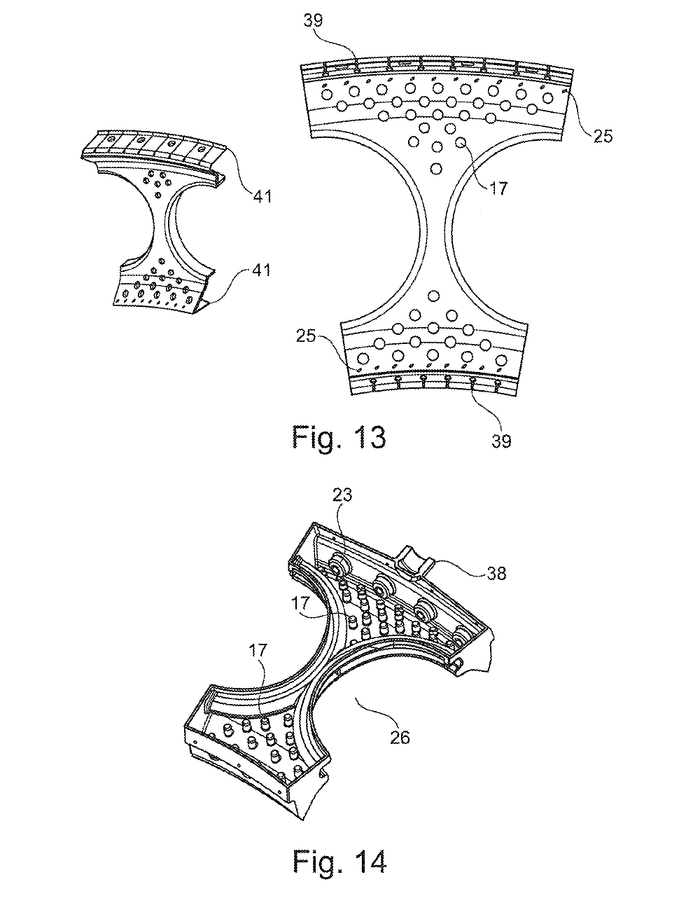

FIG. 13 shows a view, by analogy with FIG. 10, of the exemplary embodiment illustrated in FIG. 12, and

FIG. 14 shows a perspective sectional view of an enclosed segment of a combustion chamber head volume with several damping openings/outflow openings.

In the description of the exemplary embodiments, identical parts are given the same reference numerals.

In accordance with the invention, a combustion chamber head 5 (see FIG. 1) is thus provided in a combustion chamber 7 of an engine. The combustion chamber head includes a hot gas-facing, perforated wall 14 (see FIG. 2) and a rim 13 enclosing the volume 15. At least one closed volume 15 is formed. Heat shields 20 facing the combustion chamber are used to protect the perforated wall 14 from hot gas. These heat shields are designed with heat transfer-boosting elements. In accordance with the invention, the heat transfer-boosting elements 21 connect the heat shields 20 to the perforated wall 14. These elements have holes 17 which connect the damping volume 15 to the combustion chamber.

The air necessary for cooling the heat shield at the combustion chamber head passes into it via inlet openings 16 on the burner side. The air is here passed along a flow duct around the mounting of a burner seal 28. As illustrated in FIG. 2, the air is here deflected several times before it enters the flow duct 29 formed by the heat shields 20, the perforated wall 14 and the heat transfer-boosting elements 21.

FIG. 8 shows an alternative supply of the heat shield cooling air out of the recess for receiving the burner seal 28. A flow of increased velocity will form inside the cooling duct 29 (see FIG. 4a). It absorbs heat via heat transfer-boosting elements 21 and thus leads to cooling of the component.

The flow initially runs parallel to the wall 20 and is routed radially inwards or outwards in the direction of the combustion chamber inner or outer wall, respectively, relative to the combustion chamber axis or engine axis, respectively. At the end of the duct, there are openings 25 which guide the air out of the duct to the combustion chamber.

The design in accordance with the invention as shown in FIG. 2 has no connecting openings between the flow duct 29 and the volume 15. The air necessary for flushing the volume is here supplied via openings 32 in the enclosing rim 13. The position of the openings is arbitrary here, and they can be arranged on the burner side or on the compressor side. The axial length of this inflow opening to the damping volume can be varied between a few millimeters and several centimeters for optimizing the individual damping effect (cf. here FIGS. 2 and 8). The important point is that the air from the main flow is routed directly into the volume without mixing beforehand with the cooling air for the heat shields. In this way, the two air quantities are kept separate from one another. The air from the volume passes via the openings 17 into the combustion chamber which openings lead through the heat transfer-boosting elements. Here the flows of air through the openings 17 and the flow duct 29 intersect without mixing with one another. A similar design is shown in FIG. 12. The cooling air is shown here as a solid arrow, the damping air as a dashed arrow and the starter film as a dotted arrow.

In a further design in accordance with the invention, the flow duct 29 can be connected to the volume 15 via openings 31 (see FIG. 8). These permit the flushing of the volume with air from the flow duct. The air can then pass into the combustion chamber via the openings 17 routed through the heat transfer-boosting elements. The two airflows intersect here without mixing with one another.

The proportions of the air quantities can be set using the ratio of the sizes of the openings 31 and 25.

A combination of the two variants described above can also be used.

Optionally, the heat shields can contain further openings connecting the flow duct to the combustion chamber. These openings can be inclined at an angle of 10-90° to the surface and be used for film cooling of the heat shields.

The volume 15 is preferably dimensioned such that a plenum-like flow is assured to the outlet holes. This occurs in the event that the flow to the outlet holes is no longer influenced by the supply air. A distance between at least 2 mm and substantially the length of the burner head can be selected. If the distance of the rim 13 and the wall 14 is selected depending on the frequency to be expected, the volume acts as a resonator. The volume can be designed as a volume which is continuous over the circumference. The volume can be segmented by partition walls both in the circumferential direction and in the radial direction or in the axial direction. In the case of a segmented volume, the volume segments can be dimensioned optionally with equal or different size.

The damping openings 17 do not have to terminate flush with the side 14 facing the damping volume 15. They can project from the wall 14 into the volume 15 (see FIG. 12). The length of the damping openings can thus be set as a function of the resonance frequencies. The ratio of the cross-sectional surface of the opening 17 and the length of the opening 17 can be selected as a function of a frequency. The number of openings per burner sector can vary from 1 to 1000. A design in accordance with the invention with only one damping opening is shown in FIGS. 9 and 10. Optionally, it is possible with this arrangement to use heat transfer-boosting elements 21 (see FIG. 9) too.

Alternatively, individual, or also groups of, outflow openings 17 can pass through individual heat transfer-boosting elements 21. The elements can be arranged in any way. The cross-section of the elements can be of any shape. The function can be further optimized as a result of this. By way of example, an aerodynamic profile is shown in FIGS. 3d and 4d and a circular profile in FIGS. 3e and 4e. Rectangular, rhomboidal, hexagonal, elliptical and prismatic sections are also possible. A combination of the above profiles can also be used, as can profiles formed by the overlapping of circular segments. Optionally, all or part of the heat transfer-boosting elements can be designed with damping openings.

Due to the mass ratios, the entire combustion chamber is preferably connected via the combustion chamber head to the combustion chamber casing 8 or 9 by a pin-shaped suspension 38. The design of the combustion chamber head can be optionally in one piece as an integral component, or in several pieces of several segments (see FIG. 11, here for example 18 pieces). The combustion chamber walls 18 can be connected to the combustion chamber head 5 by fastening elements 23. Other connections of the combustion chamber to the combustion chamber casing(s) are possible according to the state of the art. With a multi-piece design of the heat shield, the intermediate gaps can be sealed with sealing strips (in accordance with the state of the art for turbine air guide vanes).

Setting a gap 25 between the combustion chamber walls 18 and the heat shields (see FIG. 2) enables an initial cooling film to be applied on the combustion chamber wall 18. Alternatively, outlet openings (25 in FIGS. 9 and 12) inclined in the direction of the combustion chamber wall are integratable into the heat shields 20 promoting (secondarily, as per 37) or replacing the formation of a first cooling film. In FIG. 12 a primary fresh cooling film is formed by inlet openings 34 along the connecting arms 41 of the heat shields and/or from the combustion chamber wall 35. To ensure that the cooling air for the primary and the secondary starter film does not mix prematurely (before entering the combustion chamber), one or more sealing lips 40 are integrated in accordance with the invention. They are also used for axial positioning of the heat shields 20.

Alternatively, the combustion chamber wall may be of the double-wall type, including an inner wall 33 facing the hot gas and a side 18 facing the cold outward flow. The combustion chamber outer and the inner walls may optionally be perforated. The volume formed between the combustion chamber outer and inner walls is connectable to the air from the heat shields by one or more flow ducts. One or more heat shields 20 can optionally be designed integrally with the combustion chamber head 5 or connected to the combustion chamber head by a friction, positive or bonded connection. In FIGS. 2 and 8, a bonded (e.g. welded, brazed) or a friction (bolted) connection is optionally provided by the rim surrounding the burners. Alternatively, the heat shields can also be axially connected to the combustion chamber head via webs and nuts according to the state of the art. The design shown in FIGS. 9 and 12 is advantageous in accordance with the invention, where the heat shields are radially fastened to the combustion chamber walls by flexible connecting arms 41 and to the combustion chamber head by the fastening elements 23. The thermo-mechanical loads applied on the connecting arms 41 are reduced by the flexibility thanks to the slots 39. The slots 39 also serve to cool the fastening elements 23 and supply the primary starter film 36 with fresh cooling air.

Further forms of the heat transfer-boosting elements are shown in FIG. 4b. In this way, ribs, cylinders or indentations can be applied to the heat shield. The elements can be optionally applied on the heat shield 20 or on the perforated wall 19.

The opening 25 of the flow duct 29 facing the combustion chamber can be designed with a flow-guiding heat shield lip 30 (FIG. 5). The heat shield lip may contain ribs inclined in the circumferential direction on the side facing the flow duct 29,

### LIST OF REFERENCE NUMERALS

1 Front fan/fan
2 Compressor
3 Bypass flow
4 Compressor stator wheel
5 Combustion chamber head
6 Burner with arm and head
7 Combustion chamber
8 Combustion chamber outer casing
9 Combustion chamber inner casing
10 Turbine stator wheel
11 Turbine
12 Drive shaft (machine axis)
13 Wall (rim) of combustion chamber head volume facing the compressor
14 Wall (rim) of combustion chamber head volume facing the turbine (wall including 19, 20, 21, 22, 29)
15 Enclosed combustion chamber head volume
16 Cooling air inlet opening
17 Damping opening/outflow opening
18 Combustion chamber outer wall
19 Partition wall damping volume-cooling duct
20 Partition wall cooling duct-combustion chamber (heat shield)
21 Heat transfer-boosting element (web) between 19 and 20
22 Damping opening in web 21
23 Fastening element
24 Wall cooling
25 Outlet opening (to starter film)
26 Opening in combustion chamber head 5 for burner 6
27 Axis of burner 6
28 Seal between combustion chamber head 5 and burner 6
29 Cooling air duct
30 Heat shield lip
31 Connecting openings
32 Openings for flushing the volume/inflow opening
33 Combustion chamber inner wall (tiles)
34 Inlet openings for primary starter film
35 Additional inlet openings for primary starter film
36 Primary starter film
37 Secondary starter film
38 Pin-shaped combustion chamber suspension
39 Slots
40 Sealing lip
41 Flexible connecting arms
42 Combustion chamber inner wall

What is claimed is:

1. A combustion chamber head of a gas turbine having a combustion chamber with a substantially annular combustion chamber outer wall; a substantially annular combustion chamber inner wall; and a plurality of burners distributed around a circumference, the combustion chamber head comprising:
an inflow-side wall;
a wall facing a combustion chamber;
a combustion chamber head volume formed by the inflow-side wall and the wall facing the combustion chamber;
the inflow-side wall having at least one inflow opening;
the wall facing the combustion chamber having at least one outflow opening connecting the combustion chamber head volume to the combustion chamber;
at least one cooling air duct provided in the wall facing the combustion chamber.

2. The combustion chamber head of claim 1, wherein the cooling air duct includes at least one cooling air inlet opening in a passage area of a burner.

3. The combustion chamber head of claim 2, wherein the cooling air duct includes at least one cooling air outlet opening on a radially outer area of the wall facing the combustion chamber with reference to a burner axis, via which cooling air is supplied as a starter film to the combustion chamber outer wall or inner wall.

4. The combustion chamber head of claim 3, wherein the wall facing the combustion chamber includes a double-wall configuration having multiple partition walls.

5. The combustion chamber head of claim 4, wherein the cooling air duct is positioned between the multiple partition walls, and further comprising a web-like element positioned in the cooling air duct between the partition walls with the outflow opening being positioned in the web-like element.

6. The combustion chamber head of claim 5, wherein the web-like element has a structured design for boosting a heat transfer from the cooling air.

7. The combustion chamber head of claim 6, wherein the outflow opening is configured as a damping opening.

8. The combustion chamber head of claim 7, wherein the outflow opening has a cross-section non-constant over its length.

9. The combustion chamber head of claim 7, wherein the outflow opening has a cross-section non-circular in profile.

10. The combustion chamber head of claim 1, wherein the combustion chamber head includes individual segments adjacent to one another over the circumference.

11. The combustion chamber head of claim 1, wherein the combustion chamber head includes at least one combustion chamber head volume for each burner.

12. The combustion chamber head of claim 1, wherein a connection between the combustion chamber head and one of the combustion chamber walls is bolted, welded, riveted or brazed.

13. A method for cooling and damping a combustion chamber head of a gas turbine, comprising:
routing damping air through a combustion chamber head volume in the combustion chamber head and supplying the damping air to the combustion chamber;
routing cooling air through at least one cooling air duct in a wall facing the combustion chamber;
conducting flows of the damping air and the cooling air independently of one another.

14. The method of claim 13, wherein the damping air is routed substantially in an axial direction relative to a machine axis of the gas turbine, while the cooling air is routed substantially in a radial direction, starting from a center axis of a burner.

15. The method of claim 14, comprising supplying the cooling air exiting the cooling air duct to a combustion chamber wall as a starter film.

16. A method for cooling and damping a combustion chamber head of a gas turbine, comprising:
providing a gas turbine with a combustion chamber having a substantially annular combustion chamber outer wall; a substantially annular combustion chamber inner wall; and a plurality of burners distributed around a circumference and a combustion chamber head;
providing the combustion chamber head with:
an inflow-side wall;
a wall facing a combustion chamber;
a combustion chamber head volume formed by the inflow-side wall and the wall facing the combustion chamber;
the inflow-side wall having at least one inflow opening;
the wall facing the combustion chamber having at least one outflow opening connecting the combustion chamber head volume to the combustion chamber;
at least one cooling air duct provided in the wall facing the combustion chamber.
routing damping air through the combustion chamber head volume in the combustion chamber head and supplying the damping air to the combustion chamber;
routing cooling air through the at least one cooling air duct;
conducting flows of the damping air and the cooling air independently of one another.
